(19) United States
(12) Patent Application Publication
(10) Pub. No.: US 2026/0160353 A1
(43) Pub. Date: Jun. 11, 2026

(54) SYSTEMS AND METHODS FOR CONTROLLING VALVE ACTUATORS

(71) Applicant: Hayward Industries, Inc., Charlotte, NC (US)

(72) Inventor: Maxwell S. Dehaven, Warwick, RI (US)

(73) Assignee: Hayward Industries, Inc., Charlotte, NC (US)

(21) Appl. No.: 19/356,467

(22) Filed: Oct. 13, 2025

Related U.S. Application Data
(60) Provisional application No. 63/706,331, filed on Oct. 11, 2024.

(51) Int. Cl. F16K 31/04; E04H 4/12; H04L 12/28

(52) U.S. Cl. CPC F16K 31/046; H04L 12/281; H04L 12/2814; E04H 4/12

(57) ABSTRACT

Systems and methods for controlling valve actuators are provided. The system includes an interface circuit in electrical communication with a wiring connection from a pool/spa control system, and a processor in communication with the interface circuit. The interface circuit extracts a plurality of encoded bits transmitted to the interface circuit from the pool/spa control system over the wiring connection. The plurality of encoded bits could include Manchester-encoded bits that are encoded by the pool/spa control system by altering signals transmitted to the interface circuit over the wiring connection. The processor receives the plurality of encoded bits from the interface circuit and processes the plurality of encoded bits into a control command for controlling operation of the valve actuator. When a valid control command has been generated, the processor executes the control command to operate the valve actuator in accordance with the control command.

### RELATED APPLICATIONS

The present application claims the benefit of U.S. Provisional Application Ser. No. 63/706,331 filed on Oct. 11, 2024, the entire disclosure of which is expressly incorporated herein by reference.

### BACKGROUND

### Technical Field

The present disclosure relates generally to the field of valve actuators. More specifically, the present disclosure relates to systems and methods for controlling valve actuators.

### Related Art

Valve actuators are devices that are often utilized in the pool and spa industry to remotely control fluid flow through various fluid branches of a pool/spa filtration system. An example of such an actuator is the HAYWARD GVA-24 valve actuator which controls 2- or 3-port valves and can be remotely controlled by a pool/spa control system, such as the HAYWARD PRO LOGIC, AQUA LOGIC, and OMNI LOGIC control systems. This valve actuator is connected to the control system using a 24 volt wiring connection between the control system and the valve actuator (which supplies, e.g., 24 volt AC power to the valve actuator from the pool/spa control system). To remotely actuate the valve actuator to an open or a closed position, the pool/spa control system sends either a “clockwise” operation signal or a “counterclockwise” operation signal to the valve actuator over the wiring connection, which causes the valve actuator to rotate in either a clockwise or counterclockwise direction until a pre-set limit switch within the actuator is closed, causing the valve actuator to stop rotation. The 24 volt wiring connection between the control system and the valve actuator typically includes three conductors: a first conductor through which the clockwise operation signal is transmitted, a second conductor through which the counterclockwise operation signal is transmitted, and a third conductor which serves as an electrical common or “neutral” conductor (common to the first and second conductors).

While existing valve actuators are very useful in remotely controlling pool/spa fluid operations, they are limited in the operations that they can perform. As such, it would be desirable to extend the number of operations capable of being performed by existing valve actuators using a minimal number of additional components, as well as allowing for remote control of such extended operations using the existing wiring connection provided between a valve actuator and a pool/spa control system.

Manchester encoding is a data communications technique that allows for the transmission of binary information using a form of binary phase-shift keying (BPSK), wherein the binary data to be transmitted is encoded by controlling changes of transition states of a carrier wave (e.g., a state change from a first state (e.g., first voltage level) to a second state (e.g., second voltage level) could correspond to a binary “0” while a state change from the second state (second voltage level) to the first state (first voltage level) could correspond to a binary “1”). A benefit to such encoding is that it is self-clocking and works well with a variety of circuits.

Accordingly, what would be desirable, but has not yet been provided, are systems and methods for controlling valve actuators which address the foregoing and other needs.

### SUMMARY

The present disclosure relates to systems and methods for controlling valve actuators. The system includes an interface circuit in electrical communication with a wiring connection from a pool/spa control system, and a processor in communication with the interface circuit. The interface circuit extracts a plurality of encoded bits transmitted to the interface circuit from the pool/spa control system over the wiring connection. The plurality of encoded bits could include Manchester-encoded bits that are encoded by the pool/spa control system by altering signals transmitted to the interface circuit over the wiring connection. The processor receives the plurality of encoded bits from the interface circuit and processes the plurality of encoded bits into a control command for controlling operation of the valve actuator in response to the plurality of encoded bits. When a valid control command has been generated, the processor executes the control command to operate the valve actuator in accordance with the control command.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIG. 2 is an electrical schematic diagram of the valve controller circuit of FIG. 1 in greater detail;

FIG. 3 is a state diagram illustrating control processes carried out by the valve controller firmware 14 of FIGS. 1-2 for detecting whether a valid bit has been transmitted to the valve controller circuit;

FIG. 4 is a state diagram illustrating control processes carried out by the valve controller firmware 14 of FIGS. 1-2 for performing Manchester decoding of signals received by the valve controller circuit;

FIG. 5 is state diagram illustrating control processes carried out by the valve controller firmware 14 of FIGS. 1-2 for processing Manchester bits received by the valve controller circuit and constructing and executing a control packet for controlling operation of the valve controller circuit;

FIGS. 6-7 are diagrams illustrating clockwise (CW), counterclockwise (CCW) and phase control signals generated by the valve controller circuit of FIGS. 1-2;

FIG. 8 is a diagram illustrating clockwise (CW), counterclockwise (CCW), and phase control signals generated by the valve controller circuit of FIGS. 1-2, in addition to a sinusoidal input AC line signal corresponding to the control signals.

FIG. 9 is a diagram illustrating a control packet format in accordance with the systems and methods of the present disclosure for controlling a valve actuator;

FIG. 10 is a table illustrating a plurality of control commands in accordance with the systems and methods of the present disclosure for controlling a valve actuator; and

FIG. 11 is table illustrating a plurality of operational modes capable of being implemented by the systems and methods of the present disclosure.

### DETAILED DESCRIPTION

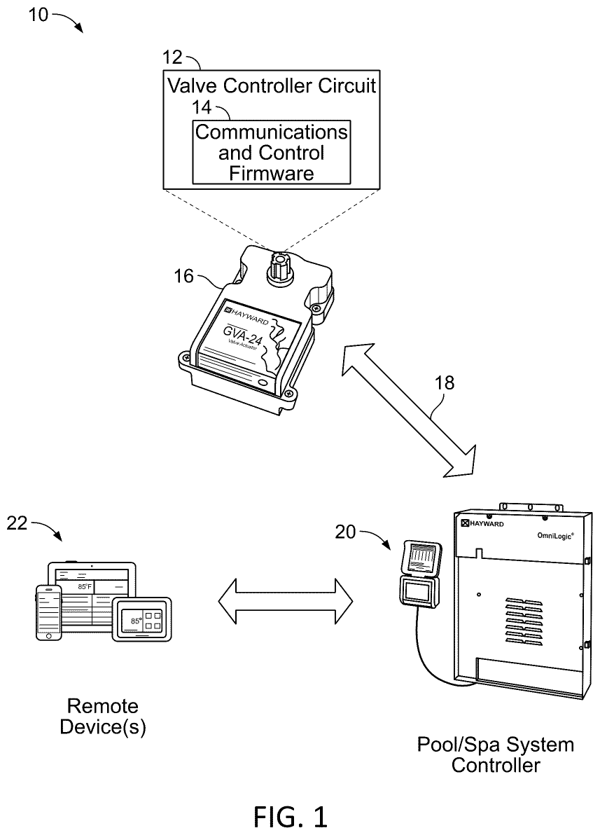

The present disclosure relates to systems and methods for controlling valve actuators, as described in detail below in connection with FIGS. 1-11.

FIG. 1 is a diagram illustrating the system of the present disclosure, indicated generally at 10. The system 10 includes a valve controller circuit 12 having communications and control firmware 14, both of which form part of a valve actuator 16. The circuit 12 and firmware 14 allow the valve actuator 16 to communicate with, and to be remotely controlled by, a controller such as a pool/spa control system 20 via a conventional (e.g., existing) wiring connection 18 between the valve actuator 16 from the control system 20. One or more remote devices 22 (such as a smart phone, tablet computer, remote user interface, etc.) could be in wired or wireless (e.g., Bluetooth) communication with the pool/spa system controller 20, such that status information and control commands could be exchanged between the remote device 22 and the valve actuator 16 via the pool/spa system controller 20 and the wiring connection 18. As will be discussed in greater detail below, the valve controller circuit 12 and the communications and control firmware 14 allow for data to be exchanged between the valve actuator 16 and the pool/spa system controller 20 using a Manchester-encoded communications protocol operating over the wiring connection 18. It is noted that the wiring connection 18 could supply alternating current (AC) power and/or direct current (DC) power to the valve actuator 16.

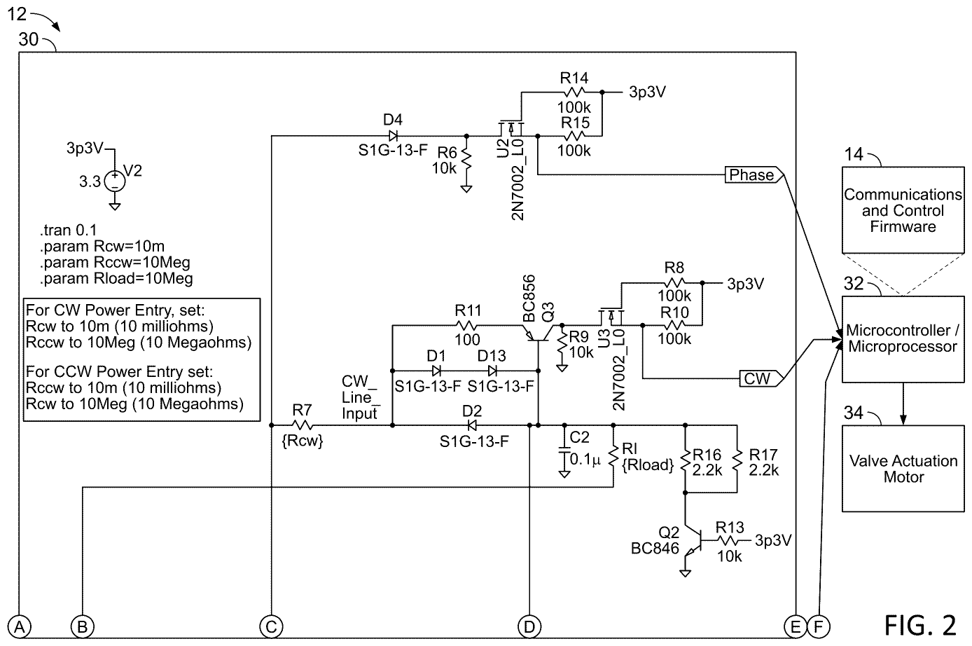

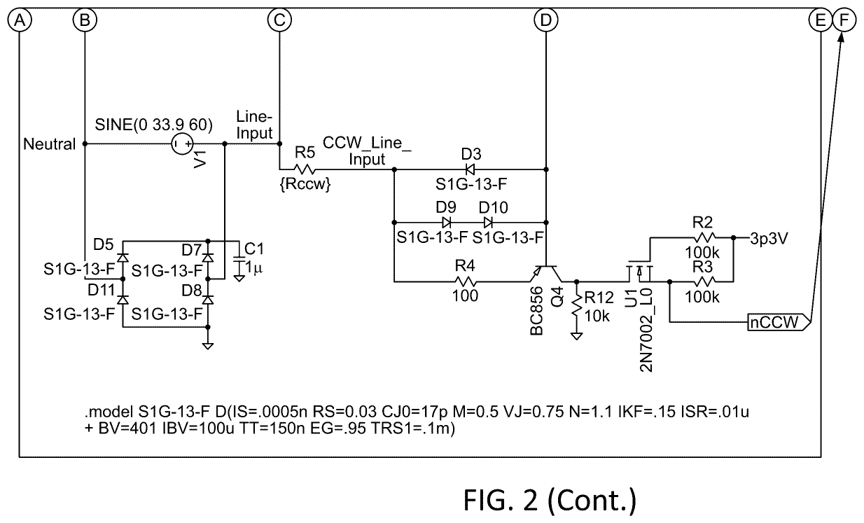

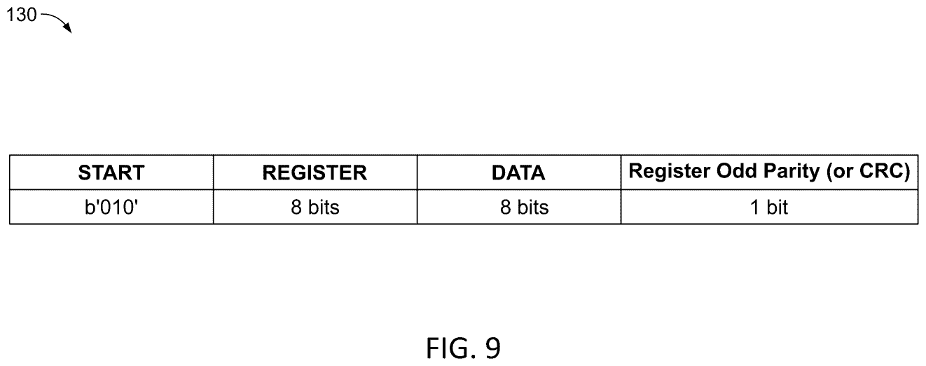

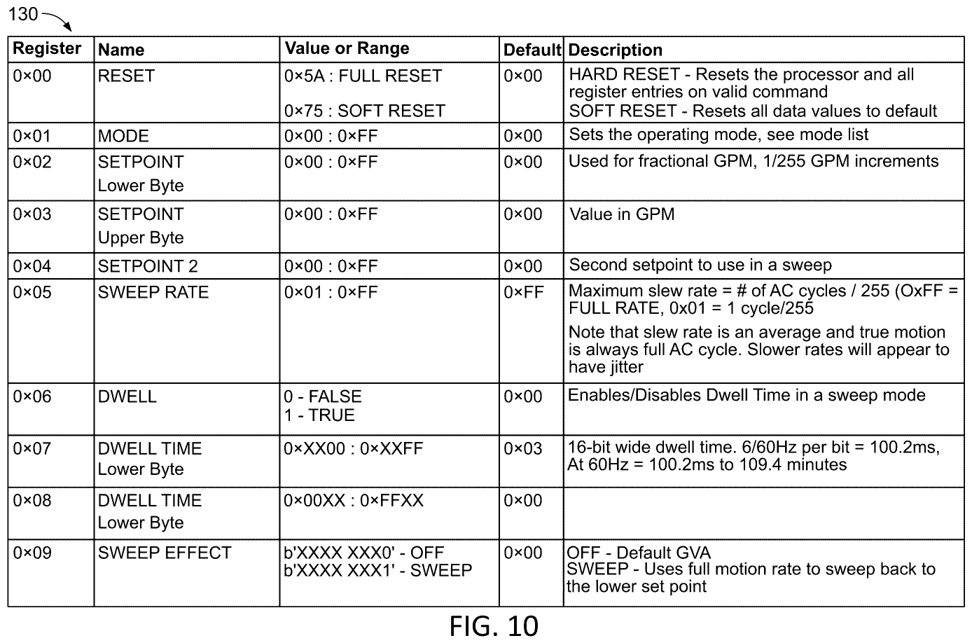

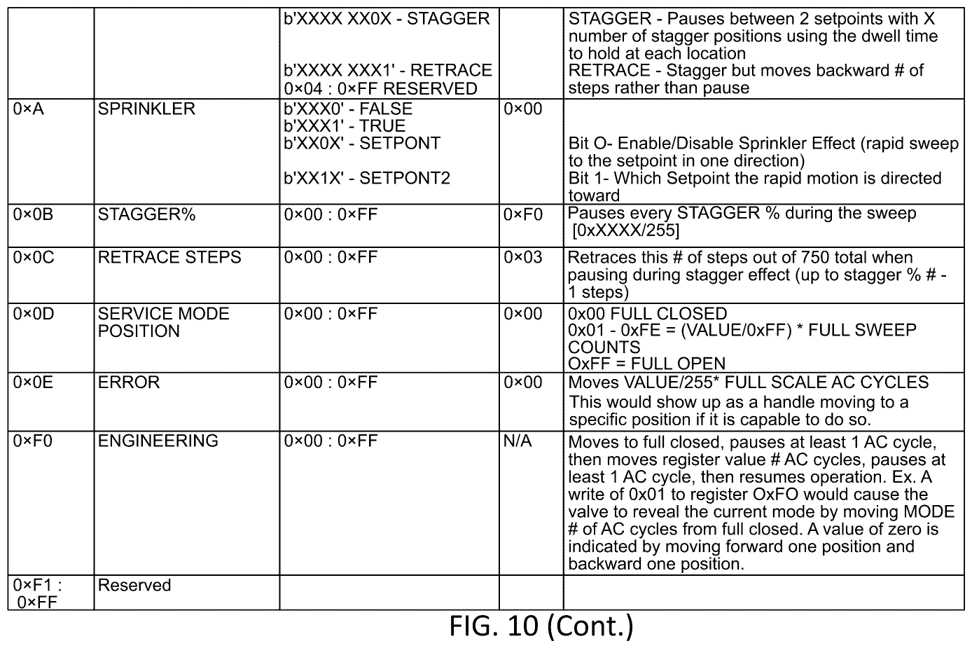

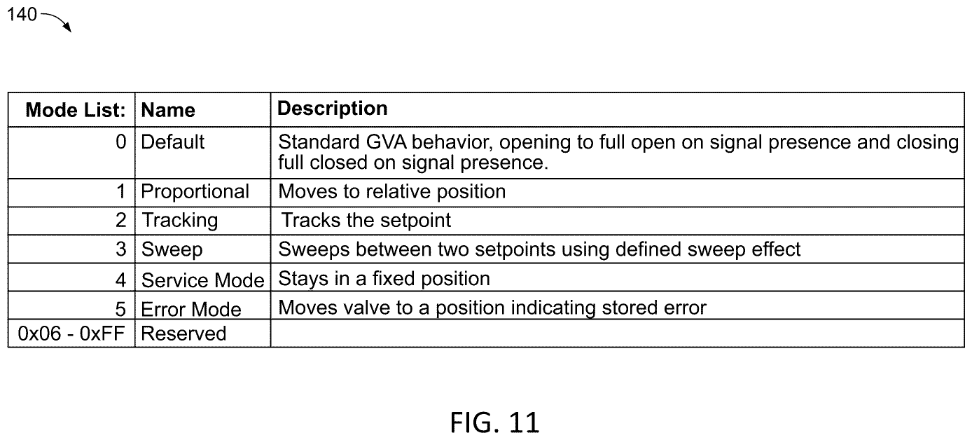

FIG. 2 is an electrical schematic diagram of the valve controller circuit 12 of FIG. 1 in greater detail. Importantly, the valve controller circuit 12 allows the pool/spa control system 20 to control a wide variety of operational aspects of the valve actuator 16 beyond what is ordinarily permitted by existing valve actuators, using Manchester-encoded “clockwise” or “counterclockwise” valve operation signals issued by the pool/spa control system 20 and without requiring any additional hardware to be added to the pool/spa control system 20 or any additional wiring (beyond the wiring connection 18) between the pool/spa control system 20 and the valve actuator 16. In particular, the pool/spa control system 20 can Manchester-encode binary information using an encoding scheme such as that discussed herein in connection with FIGS. 10 and 11 by alternating signal applied to the clockwise and counterclockwise conductors of the wiring connection 18 to the valve actuator 16, which signals are then received by the valve actuator 16, decoded by the control circuit 12, and executed to provide a wide variety of control options such as discussed in connection with FIGS. 9-11 below. It is noted that the alternation of the signals applied to the clockwise and counterclockwise conductors for purposes of Manchester-encoding could be achieved using a suitable switch, transistor, and/or relay forming part of the pool/spa system controller 20, under software control by a processor of the controller 20.

The valve controller circuit 12 includes an interface circuit 30 which extracts the Manchester-encoded clockwise or counterclockwise valve operation signals issued by the pool/spa system controller 20. The clockwise or counterclockwise valve operation commands are Manchester-encoded binary signals that are sent from the pool/spa controller 20 of FIG. 1 over the clockwise and counterclockwise conductors of the power line 18. For purposes of illustration and testing of the circuit 12, different input resistance values (controlled by resistors R5 and R7) to emulate switching of the Manchester-encoded states of the clockwise and counterclockwise conductors of the wiring connection 18 (e.g.,. by a switch, transistor, relay, or other component of the pool/spa system controller 20). Specifically, by setting resistor R7 to 10 milliohms and resistor R5 to 10 Megaohms, the circuit 12 outputs a Manchester-encoded clockwise (“CW”) signal (e.g., indicating that power has been applied to the clockwise conductor of the wiring connection 18 and no power has been applied to the counterclockwise conductor of the wiring connection 18). Alternatively, by setting resistor R7 to 10 Megaohms and resistor R5 to 10 milliohms, the circuit 12 outputs a Manchester-encoded counterclockwise (“CCW”) signal (e.g., indicating that no power has been applied to the clockwise conductor of the wiring connection 18 and power has been applied to the counterclockwise conductor of the wiring connection 18). It is these alternating input states which convey Manchester-encoded information. The circuit 12 also outputs a binary “phase” signal that changes bit state every time the phase of the AC input signal changes. Since, as noted above, the resistors R5 and R7 are provided solely for testing of the circuit 12 and simulation of a switch, transistor, or relay, the resistors R5 and R7 need not be included in the circuit 12.

The Manchester-encoded phase, CW, and CCW signals are subsequently transmitted to a processor (microcontroller/microprocessor, or other suitable processing device) 32 forming part of the circuit 12 and which are interpreted by the microcontroller/microprocessor 32 using the communications and control firmware 14 to issue one or more signals for controlling operation of a valve actuation motor 34 (which controls operation of the valve actuator 16 and a valve connected to the valve actuator 16). The firmware 14 could be stored in a non-volatile memory in communication with, or forming part of, the processor 32.

The circuit 30 includes a bridge rectifier (diodes D5, D7, D8, and D11) and filtration capacitor C1 which provide direct current (DC) power from the neutral and line voltage inputs of the wiring connection 18 (represented as input V1) for powering the circuit 30. Diode D4, resistor R6, field-effect transistor U2, and resistors R14 and R15 create the phase signal supplied to the processor 32. More specifically, these components generate a binary pulse signal every time the phase of sinusoidal line voltage from the wiring connection 18 changes. It is noted that these components are optional, and have the added benefit of providing a timing signal for the valve controller circuit 12. Resistors R1, R7, R8, R9, R11, R13, R16, and R7, diodes D1, D2, and D13, field-effect transistor U3, capacitor C2, and transistor Q2 supply Manchester-encoded signals to the processor 32. It is noted that the transistor Q2 is shown being driven by 5 volts, but could be substituted with a microcontroller-driven load if desired. Finally, resistors R2, R3, R4, R5, and R12, diodes D3, D9, and D10, field-effect transistor U1, and transistor Q4 supply Manchester-encoded signals to the processor 32.

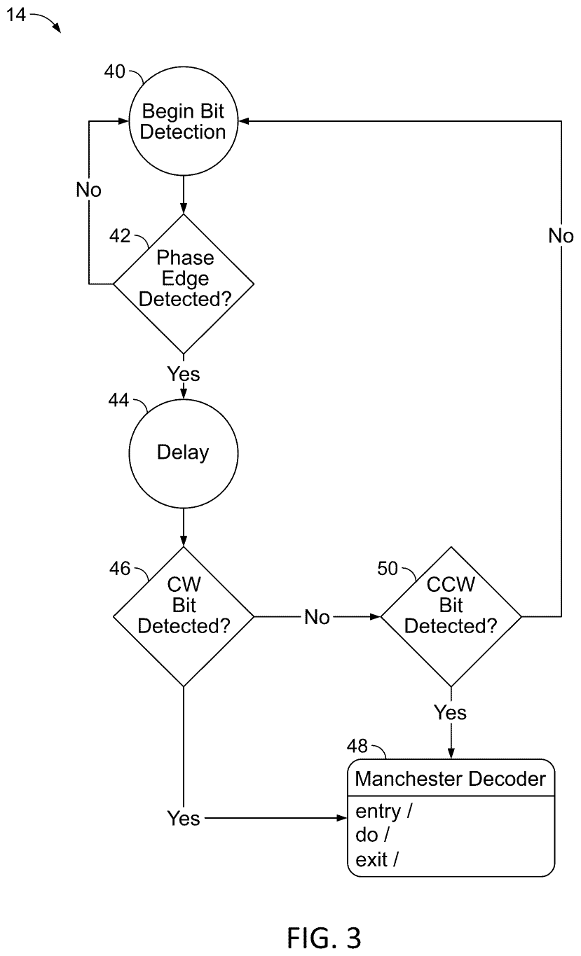

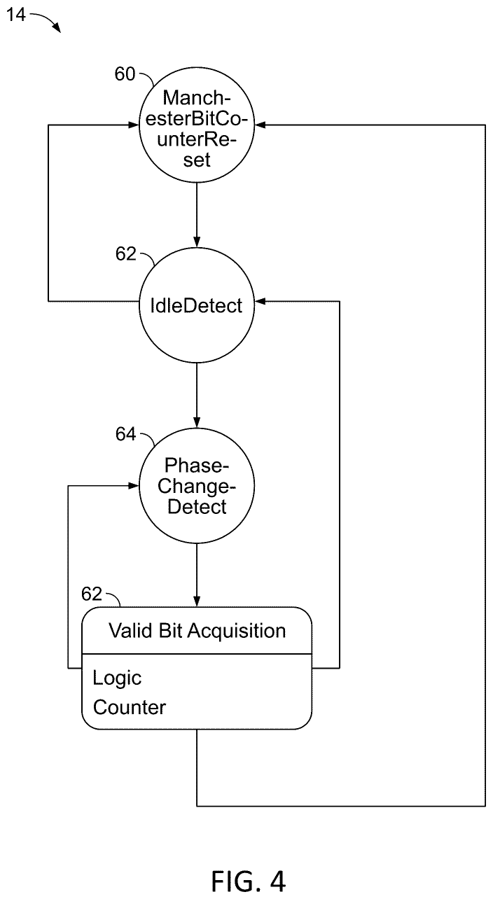

FIG. 3 is a state diagram illustrating control processes carried out by the valve controller firmware 14 of FIGS. 1-2 for detecting whether a valid bit has been transmitted to the valve controller circuit 12. In step 40, the firmware 14 begins detecting bits that are received by the circuit 30 and output as the CW, CCW, or phase signals. In step 42, a determination is made as to whether a phase edge has been detected. If not, control returns to step 40. Otherwise, step 44, occurs, wherein a pre-defined time delay is executed by the firmware. Then, in step 46, the firmware determines whether a CW bit has been detected. If so, process 48 occurs, wherein Manchester decoding of the CW bit occurs (described below in further detail in connection with FIG. 4). Otherwise, step 50 occurs, wherein a determination is made as to whether a CCW bit has been detected. If so, step 48 occurs, wherein Manchester decoding of the CCW bit occurs. Otherwise, control returns to step 40.

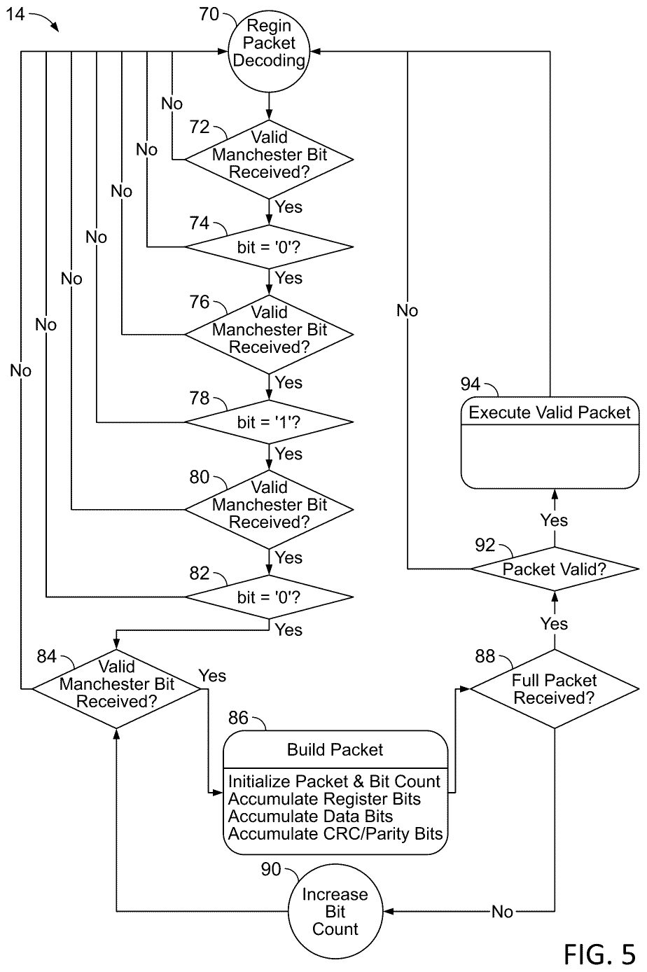

FIG. 4 is a state diagram illustrating control processes carried out by the valve controller firmware 14 of FIGS. 1-2 for performing Manchester decoding of alternating current (AC) signals received by the valve controller circuit. In step 60, the firmware resets a Manchester bit counter. Then, in step 62, the system enters an idle detection state. Next, in step 64, the firmware enters a phase change detection state, wherein the firmware detects the occurrence of a change in phase of the incoming signal. In step 62, the system performs a valid bit acquisition process, discussed in greater detail below in connection with FIG. 5.

FIG. 5 is state diagram illustrating control processes carried out by the valve controller firmware 14 of FIGS. 1-2 for processing Manchester bits received by the valve controller circuit and constructing and executing a control packet for controlling operation of the valve controller circuit. In step 70, the firmware begins packet decoding. In step 72, a determination is made as to whether a valid Manchester bit has been received. If not, control returns to step 70. Otherwise, step 74 occurs, wherein a determination is made as to whether the received Manchester bit corresponds to a binary 0 value. If not, control returns to step 70. If so, step 76 occurs, wherein a determination is made as to whether a valid Manchester bit has been received. If not, control returns to step 70. Otherwise, step 78 occurs, wherein a determination is made as to whether the received Manchester bit corresponds to a binary 1 value. If not, control returns to step 70. Otherwise, step 80 occurs, wherein a determination is made as to whether a valid Manchester bit has been received. If not, control returns to step 70. Otherwise, step 82 occurs, wherein a determination is made as to whether the received Manchester bit corresponds to a binary 0 value. If not, control returns to step 70. Otherwise, process 86 occurs, wherein a packet construction process occurs. As will be appreciated, steps 70-84 ensure that a valid sequence of Manchester-encoded bits corresponding to binary “preamble” sequence 010 are received by the firmware before any further processing can occur, which ensure that the firmware 14 (and hence, the valve control circuit 12 and valve actuator 16) will only respond to valid command messages that begin with the binary sequence 010. Of course, any other preamble sequences could be utilized without departing from the spirit or scope of the present invention.

In process 86, the firmware constructs a command packet by initializing a packet and bit counter, accumulating register bits (which are Manchester-encoded and received over the AC line), accumulating data bits (which are also Manchester-encoded and received over the AC line), and accumulating cyclic redundancy check (CRC) and/or parity bits (which are also Manchester-encoded and received over the AC line). In step 88, a determination is made as to whether a full packet has been constructed. If not, step 90 occurs, wherein the firmware increases the bit counter, and control returns to step 84. Otherwise, step 92 occurs, wherein a determination is made as to whether the packet is valid. If not, control returns to step 70. Otherwise, step 94 occurs, wherein the firmware executes the packet.

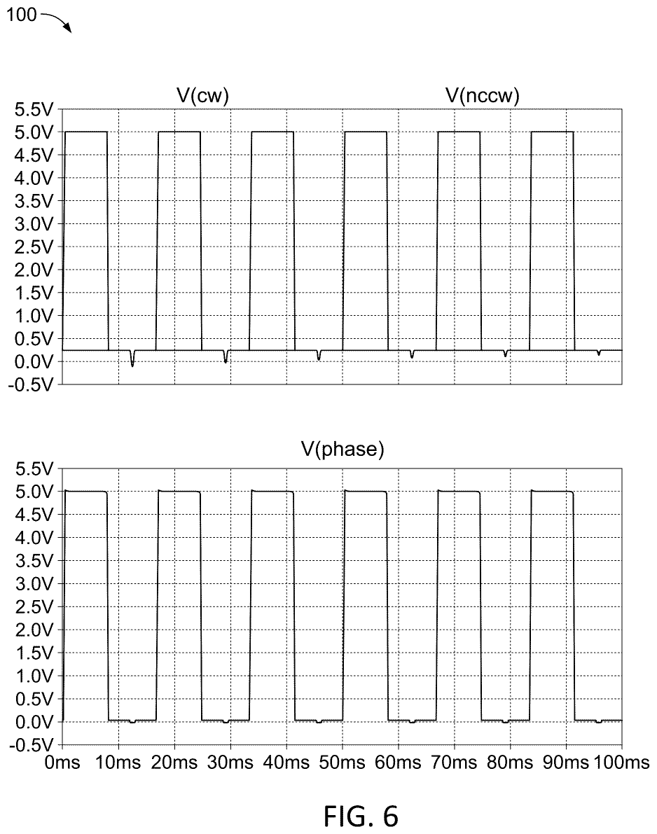

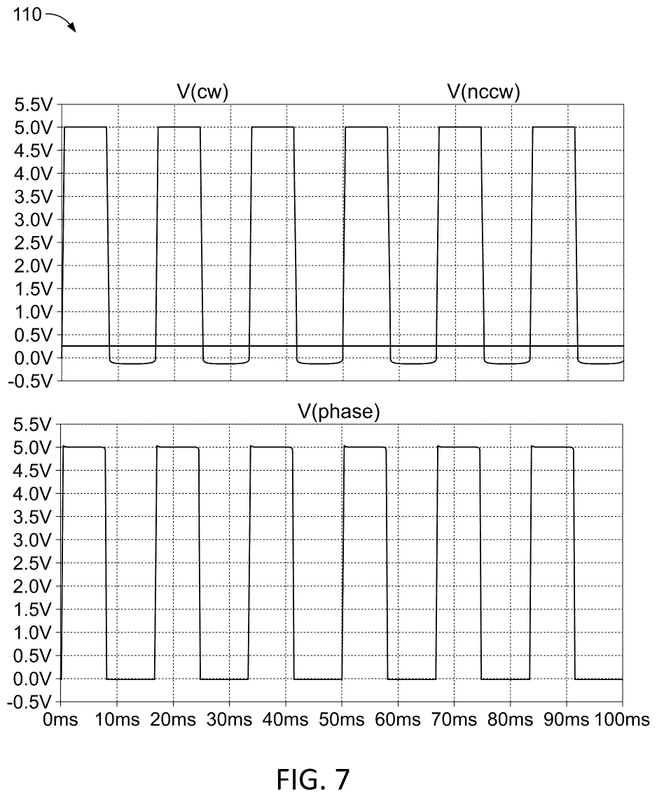

FIGS. 6-7 are diagrams illustrating clockwise (CW), counterclockwise (CCW) and phase control signals generated by the valve controller circuit 12 of FIGS. 1-2. As can be seen in the graphs 100 of FIG. 6, the circuit 12 outputs Manchester-encoded CW bits (represented as square wave V(cw)) and no Manchester-encoded CCW bits. The circuit 12 also outputs the binary phase change signal shown as square wave V(phase). As can be seen in the graphs 110 of FIG. 7, the circuit 12 outputs Manchester-encoded CCW bits (represented as square wave V(nccw)) and no Manchester-encoded CW bits. The circuit 12 also outputs the binary phase change signal shown as square wave V(phase).

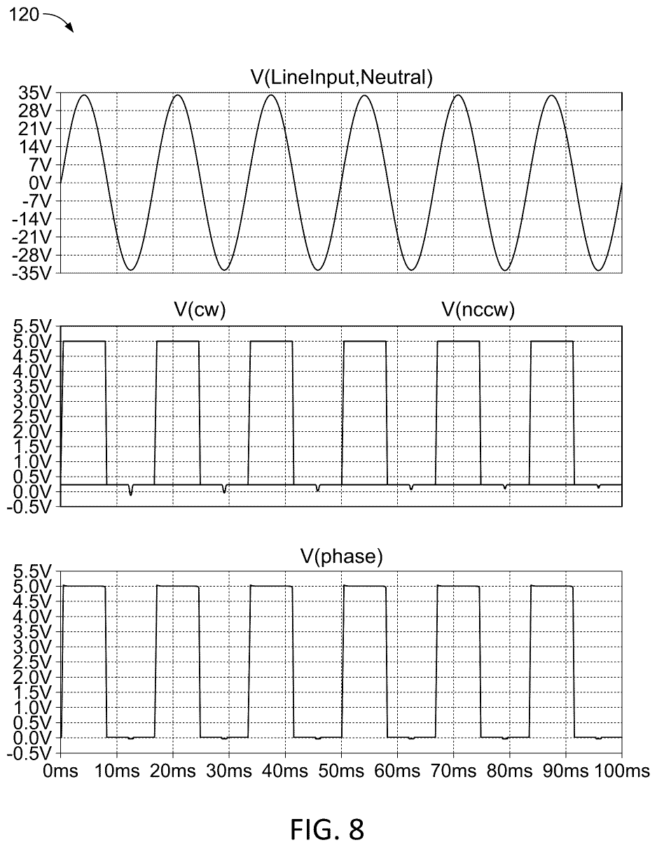

FIG. 8 is a diagram illustrating clockwise (CW), counterclockwise (CCW), and phase control signals generated by the valve controller circuit of FIGS. 1-2, in addition to a sinusoidal input AC line signal corresponding to the control signals. As can be seen in the graphs 120, the sinusoidal AC line signal is shown as the sine wave V(LineInput. Neutral), and the circuit 12 outputs Manchester-encoded CW bits (represented as square wave V(nccw)) and no Manchester-encoded CCW bits. The circuit 12 also outputs the binary phase change signal shown as square wave V(phase).

FIG. 9 is a diagram illustrating a control packet format 130 in accordance with the systems and methods of the present disclosure for controlling a valve actuator. As can be seen, the control packet format 130 includes a start field that includes the aforementioned “010” binary preamble, a register field that is 8 bits in length and defines one or more register of the microprocessor/microcontroller 32 into which data and/or commands are to be stored, a data field that is 8 bits in length and includes “payload” data and/or commands transmitted to the valve actuator 16 from the pool/spa control system 20, and a register odd parity (or, CRC) field of 1 bit in length. The pool/spa control system 20 can be programmed to transmit Manchester-encoded binary bits (over wiring connection 18) in a format that conforms to the control packet format 130, so as to remotely command a wide variety of control operations and modes of the valve actuator such as those discussed in connection with FIGS. 10-11. Advantageously, no additional hardware is required to be added to either the pool/spa control system or the AC line 18.

FIG. 10 is a table illustrating a plurality of control commands 130 in accordance with the systems and methods of the present disclosure for controlling a valve actuator. The control commands are executed by the valve actuator 16 when the register field and the data field of the command packet shown in FIG. 9 are set to the values indicated in FIG. 10. The control commands include, but are not limited to, the following:
1. Reset command (register 0x00), which performs either a hard (full) reset or a soft reset of the processor 32.
2. Mode command (register 0x01), which causes the valve actuator 16 to operate in one of the modes described below in connection with FIG. 11.
3. Setpoint Lower Byte command (register 0x02), which sets a fractional (variable) flow rate for the valve actuator, specified in Gallons Per Minute (GPM). The fractional flow rate could be specified in any suitable increments, such as, but not limited to, 1/225 GPM increments.
4. Setpoint Upper Byte command (register 0x03), which specifies a flow rate for the valve actuator 16 in GPM. Advantageously, this allows the valve actuator 16 to be operated to achieve a desired flow rate.
5. Sweep Rate command (register 0x05), which specifies the maximum slew rate for the valve actuator 16. The slew rate is an average, and true motion is preferably achieved during full AC cycles. Preferably, slower slew rates are avoided so as to minimize jitter.
6. Dwell command (register 0x06), which enables or disables dwell time (at a particular position) when the valve actuator is operated in a sweep mode.
7. Dwell Time Lower Byte command (register 0x07), which specifies a desired dwell time for the valve actuator. This value could be a 16-bit wide dwell time, such that 6/60 Hz per bit is equivalent to a dwell time of 100.2 milliseconds (the dwell time being settable at 60 Hz from 100.2 milliseconds to 109.4 minutes).
8. Dwell Time Upper byte command (register 0x08)
9. Sweep Effect command (register 0x09), which specifies a desired sweep effect for the valve actuator (default setting being inactive (off); “sweep” setting utilizing full motion rate to sweep the valve actuator 16 back to the lower set point; “stagger” setting pausing the valve actuator 16 between two setpoints with X number of staggered positions using the dwell time to hold at each location; and “retrace” setting staggering the valve actuator but moving backwards a pre-defined number of steps rather than pausing).
10. Sprinkler command (register 0x0A), which enables/disables a sprinkler effect (rapid sweeping to the setpoint in one direction) and which specifies a setpoint toward which the rapid motion is directed.
11. Stagger percentage command (register 0x0B), which pauses every stagger percentage during the sweep operation.
12. Retrace Steps command (register 0x0C), which retraces a pre-defined number of steps out of 750 in total when pausing during a staggering effect (up to the stagger percentage number −1).
13. Service Mode position command (register 0x0D), which positions the valve actuator 16 in one of three service mode positions (fully closed, opened by a number of sweep counts, or fully opened).
14. Error mode (register 0x0E), which places the valve actuator 16 in an error mode (and could cause the valve handle to be moved to specific position if it is capable of doing so).
15. Engineering mode (register 0xF0), which places the valve actuator 16 in engineering mode. This could cause the valve to be moved to the fully closed position, pausing at least 1 AC cycle, then move to a register value for a predefined number of AC cycles, then pause for at least 1 AC cycle, then resume operation. For example, if register 0xF0 is written with the value 0x01, this could cause the valve actuator to reveal the current mode by moving a mode number of AC cycles from the fully-closed position. A value of zero could be indicated by moving forward one position and backward one position.
FIG. 11 is table illustrating a plurality of operational modes 140 capable of being implemented by the systems and methods of the present disclosure. The modes 140 include, but are not limited to, the following operational modes:
1. Default mode (mode 0), wherein the valve actuator 16 operates as a conventional valve actuator such that it opens a valve to the fully opened setting upon the presence of a fully open signal and closes the valve to the fully closed setting upon the presence of a fully closed signal.
2. Proportional mode (mode 1), wherein the valve actuator 16 moves the valve to a relative position (e.g., to a position in relation to the end positions of the valve actuator 16; for example, “open 10%” is a proportional movement from a fully-closed position to 10% of the rotational distance to the fully-open position (or other end position)). This mode can be achieved with or without a flow meter.
3. Tracking mode (mode 2), wherein the valve actuator 16 tracks a setpoint specified by a command sent to the valve actuator 16.
4. Sweep mode (mode 3), wherein the valve actuator 16 sweeps between two setpoints using a pre-defined sweep effect.
5. Service mode (mode 4), wherein the valve actuator 16 stays in a fixed position.
6. Error mode (mode 5), wherein the valve actuator 16 moves the valve to a position that indicates a stored error.
It is noted that the valve actuator 16 could be programmed to send a signal over the line 18 back to the pool/spa control system 20 to acknowledge that a command has been successfully transmitted to and/or executed by the valve actuator 18, and/or to transmit operational data (e.g., indicating the current status of one or more parameters/settings of the valve actuator 16).

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A system for controlling a valve actuator, comprising:
an interface circuit in electrical communication with a pool/spa control system, the interface circuit extracting a plurality of encoded bits transmitted to the interface circuit from the pool/spa control system over a wiring connection; and
a processor in communication with the interface circuit, the processor receiving the plurality of encoded bits from the interface circuit, the processor executing firmware for processing the plurality of encoded bits into a control command for controlling operation of the valve actuator in response to the plurality of encoded bits and executing the control command to operate the valve actuator in accordance with the control command.

2. The system of claim 1, wherein the plurality of encoded bits comprise Manchester-encoded bits.

3. The system of claim 1, wherein the interface extracts the plurality of encoded bits from clockwise and counterclockwise conductors of the wiring connection.

4. The system of claim 1, wherein the interface circuit generates a clockwise control signal, a counterclockwise control signal, and a phase signal from the wiring connection by the interface circuit.

5. The system of claim 1, wherein the processor controls operation of a valve actuation motor of the valve actuator to move a valve coupled to the valve actuation in accordance with the control command.

6. The system of claim 1, wherein the control command further comprises a start field, a register field, and a data field, the register field specifying a type of the control command.

7. The system of claim 6, wherein the control command comprises one of a reset command, a mode command, a setpoint command, a sweep rate command, a dwell command, a sweep effect command, a sprinkler command, a stagger command, a retrace steps command, a service mode position command, an error position command, and an engineering position command.

8. The system of claim 7, wherein the mode command instructs the valve actuator to operate in a mode comprising a default operation mode, a proportional operation mode, a tracking mode, a sweep mode, a service mode, or an error mode.

9. The system of claim 1, wherein processor constructs a packet from the plurality of encoded bits received by the interface circuit.

10. The system of claim 9, wherein the packet includes a plurality of register bits, a plurality of data bits, and at least one cyclic redundancy check (CRC) or parity bit.

11. The system of claim 9, wherein the processor validates the packet prior to executing the packet.

12. A method for controlling a valve actuator, comprising:
extracting by an interface circuit in electrical communication with a pool/spa control system a plurality of encoded bits transmitted to the interface circuit from the pool/spa control system over a wiring connection;
receiving the plurality of encoded bits by a processor in communication with the interface circuit;
processing the plurality of encoded bits by the processor into a control command for controlling operation of the valve actuator in response to the plurality of encoded bits; and
executing the control command by the processor to operate the valve actuator in accordance with the control command.

13. The method of claim 12, wherein the plurality of encoded bits comprise Manchester-encoded bits.

14. The method of claim 12, further comprising extracting the plurality of encoded bits from clockwise and counterclockwise conductors of the wiring connection.

15. The method of claim 12, further comprising generating by the interface circuit a clockwise control signal, a counterclockwise control signal, and a phase signal from the wiring connection by the interface circuit.

16. The method of claim 12, further comprising controlling by the processor operation of a valve actuation motor of the valve actuator to move a valve coupled to the valve actuation in accordance with the control command.

17. The method of claim 12, wherein the control command further comprises a start field, a register field, and a data field, the register field specifying a type of the control command.

18. The method of claim 17, wherein the control command comprises one of a reset command, a mode command, a setpoint command, a sweep rate command, a dwell command, a sweep effect command, a sprinkler command, a stagger command, a retrace steps command, a service mode position command, an error position command, and an engineering position command.

19. The method of claim 18, wherein the mode command instructs the valve actuator to operate in a mode comprising a default operation mode, a proportional operation mode, a tracking mode, a sweep mode, a service mode, or an error mode.

20. The method of claim 12, further comprising constructing a packet from the plurality of encoded bits received by the interface circuit.

21. The method of claim 20, wherein the packet includes a plurality of register bits, a plurality of data bits, and at least one cyclic redundancy check (CRC) or parity bit.

22. The method of claim 20, further comprising validating the packet prior to executing the packet.
